(19) United States
(12) Patent Application Publication
(10) Pub. No.: US 2026/0081314 A1
(43) Pub. Date: Mar. 19, 2026

(54) CONNECTION METHOD AND BATTERY PACK

(71) Applicant: TOYOTA JIDOSHA KABUSHIKI KAISHA, Toyota-shi (JP)

(72) Inventor: Kouichi HIRATSUKA, Toyota-shi (JP)

(73) Assignee: TOYOTA JIDOSHA KABUSHIKI KAISHA, Toyota-shi (JP)

(21) Appl. No.: 19/312,570

(22) Filed: Aug. 28, 2025

(30) Foreign Application Priority Data
Sep. 18, 2024 (JP) 2024-160737

(51) Int. Cl. H01M 50/569; H01M 50/505; H01R 4/48

(52) U.S. Cl. CPC H01M 50/569; H01M 50/505; H01R 4/4828; H01R 4/48455

(57) ABSTRACT

To provide a connection method adapted to connect a bus bar and a voltage detection line in such a way that the possibility of electric shock is reduced in the case of performing re-connection in an assembled battery pack. A connection method according to the present disclosure is a connection method for performing connection between the bus bar and the voltage detection line in a battery pack. In this connection method, the voltage detection line is joined to the bus bar housed in a bus bar case made of an insulating material, and a spacer is fixed to the bus bar case under a state in which the bus bar and the voltage detection line are pressed between the bus bar case and the spacer made of an insulating material to thereby bring the bus bar and the detection line in close contact with each other.

### CROSS REFERENCE TO RELATED APPLICATIONS

This application is based upon and claims the benefit of priority from Japanese patent application No. 2024-160737, filed on Sep. 18, 2024, the disclosure of which is incorporated herein in its entirety by reference.

### BACKGROUND

This disclosure relates to a connection method and a battery pack.

Patent Literature 1 describes a connection structure for connection between an insulated electric wire and a conductor part, adapted to prevent an insulated electric wire from being separated from an electric wire fixing part, which fixes the insulated electric wire, by protecting the insulation coating of the insulated electric wire from heat generated when joining the conductor wires of the insulated electric wire.

[Patent Literature 1] International Patent Publication No. WO 2020/012716

### SUMMARY

However, in the case where a battery pack is assembled by the technique described in Patent Literature 1, cautiousness against electric shock is required when re-joining the voltage detection line (i.e., an insulated electric wire) and the bus bar (i.e., a conductor) for repair. Therefore, it is desirable to develop a technique of connecting a bus bar and a voltage detection line in such a way that the possibility of electric shock is reduced in the case of re-joining the voltage detection line and the bus bar in an assembled battery pack.

The present disclosure has been made in view of the above-mentioned circumstances, and provides a connection method adapted to connect a bus bar and a voltage detection line in such a way that the possibility of electric shock is reduced in the case of performing re-connection in an assembled battery pack and a battery pack in which the method is adopted.

According to the present disclosure, a connection method for performing connection between a bus bar and a voltage detection line in a battery pack, includes: joining the voltage detection line to the bus bar housed in a bus bar case made of an insulating material; and fixing a spacer to the bus bar case under a state in which the bus bar and the voltage detection line are pressed between the bus bar case and the spacer made of an insulating material to thereby bring the bus bar and the detection line in close contact with each other.

A battery pack according to the present disclosure includes: a bus bar; a bus bar case made of an insulating material for housing bus bar; a voltage detection line joined to the bus bar in the bus bar case; and a spacer made of an insulating material and fixed to the bus bar case, in which the bus bar and the voltage detection line are fixed in close contact with each other between the bus bar case and the spacer.

According to the present disclosure, it is possible to provide a connection method adapted to connect a bus bar and a voltage detection line in such a way that the possibility of electric shock is reduced in the case of performing re-connection in an assembled battery pack and a battery pack in which the method is adopted.

The above and other objects, features and advantages of the present disclosure will become more fully understood from the detailed description given hereinbelow and the accompanying drawings.

### BRIEF DESCRIPTION OF DRAWINGS

FIG. 1 is an exploded perspective view schematically showing an example of a configuration of a battery pack in which a bus bar is to be connected to a voltage detection line by a connection method according to an embodiment;

FIG. 2 is a schematic perspective view showing an example of a bus bar module in the battery pack of FIG. 1;

FIG. 3 is a schematic diagram showing an example of a configuration of a part of a circuit in the battery pack of in FIG. 1;

FIG. 4 is a flow diagram for explaining an example of the connection method according to the embodiment;

FIG. 5 is a schematic diagram showing an example of connection adopting the connection method of FIG. 4 and an example of connection adopting a connection method of a comparative example; and

FIG. 6 is a schematic view showing a connection state according to the connection method of FIG. 4.

### DESCRIPTION OF EMBODIMENTS

Hereinafter, the present disclosure will be described through the embodiments of the disclosure, but the claimed disclosure is not limited to the following embodiments. In addition, all of the configurations described in the embodiments are not necessarily indispensable as means for solving the problem.

### Embodiment

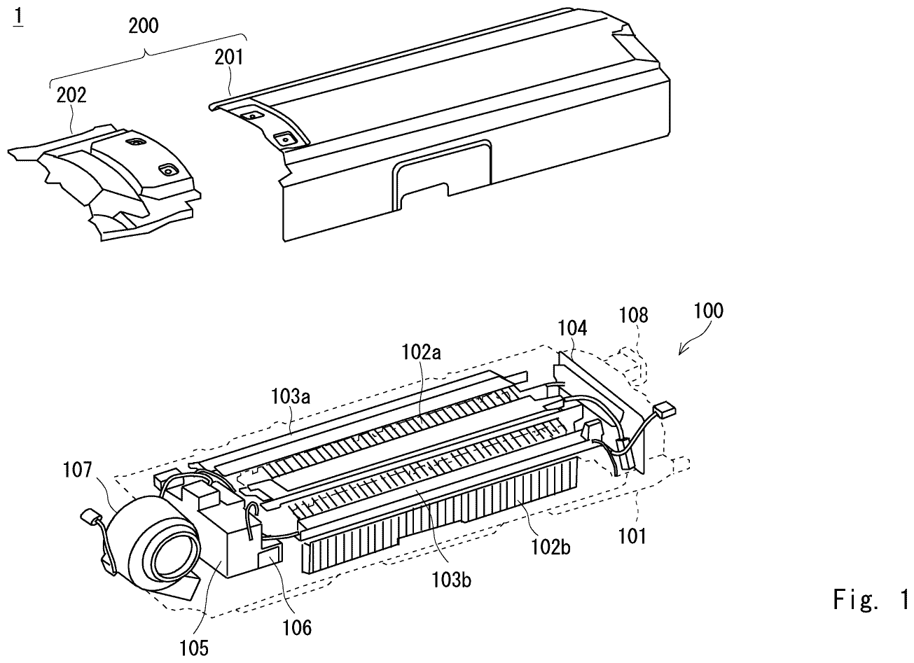

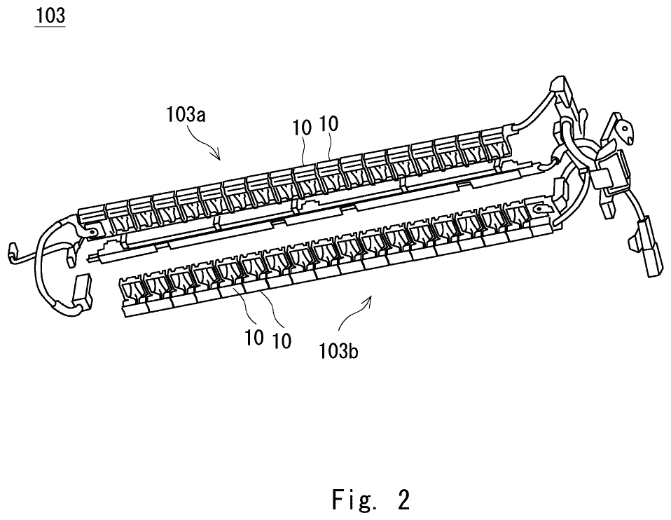

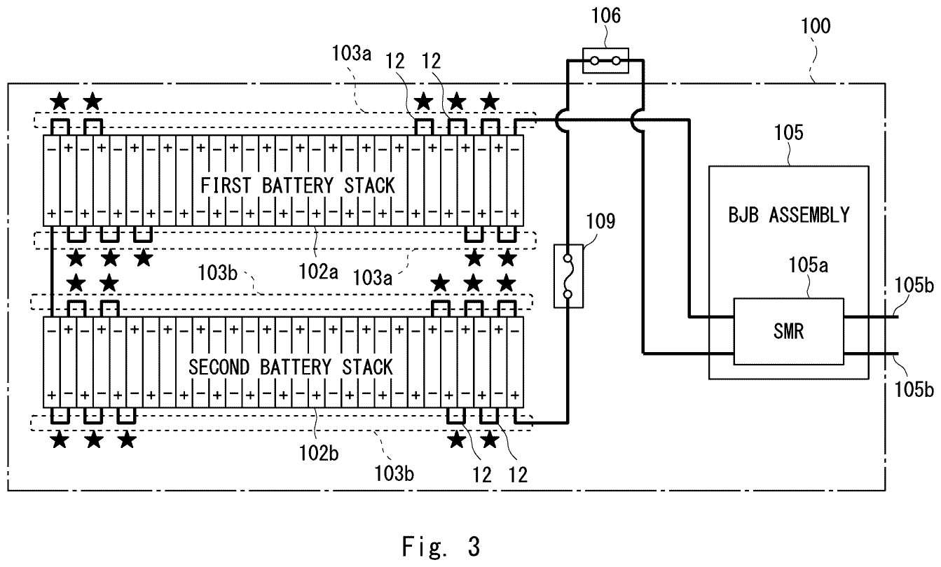

Prior to the description of a connection method according to the present embodiment, an example of a configuration of a battery pack in which a connection method according to the present embodiment is adopted in the manufacture thereof will be described with reference to FIGS. 1 to 3. FIG. 1 is an exploded perspective view schematically showing an example a configuration of a battery pack in which a bus bar is to be connected to a voltage detection line by a connection method according to a present embodiment. FIG. 2 is a schematic perspective view showing an example of a bus bar module in the battery pack of FIG. 1. FIG. 3 is a schematic view showing an example configuration of a part of a circuit in the battery pack of FIG. 1.

A battery pack 1 shown in FIG. 1 has a configuration in which a plurality of batteries are stacked and is also known as a battery module. The battery pack 1 may include, for example, a main unit 100 and a cover part 200.

The cover part 200 may be configured to be attached to the main unit 100 by engaging a first cover part 201 with a second cover part 202, for example, as illustrated in the figure. The second cover part 202 mainly covers a battery cooling blower assembly, which will be described later, and the first cover part 201 covers other parts.

The main unit 100 includes a housing 101 and a first battery stack 102a, a second battery stack 102b, a first bus bar module 103a, a second bus bar module 103b, and a battery ECU assembly 104 attached to the housing 101. ECU stands for Electronic Control Unit.

Both the first battery stack 102a and the second battery stack 102b are constituted by stacking a plurality of batteries. The batteries to be stacked may be a hybrid battery used for driving a motor among the two types of batteries installed in hybrid vehicles, or may be another type of battery.

The first bus bar module 103a and the second bus bar module 103b are battery bus bar modules including a bus bar which are attached to the electrodes of the stacked batteries in the first battery stack 102a and the second battery stack 102b, respectively. As exemplified in FIG. 2, a bus bar module 103 provided in the battery pack 1 may include the first bus bar module 103a, the second bus bar module 103b, and a connection cable for connecting the bus bar modules with other parts. The bus bar modules 103a and 103b include a bus bar case serving as a case thereof and a bus bar housed in the bus bar case, respectively. The bus bar case may be made of an insulating material such as resin.

In FIG. 2, parts of the first bus bar module 103a and the second bus bar module 103b that join the batteries corresponding to the respective bus bars are illustrated as a joining part 10. As exemplified in FIG. 3, a bus bar 12 in each of the joining parts 10 connects a positive electrode and a negative electrode between the stacked batteries.

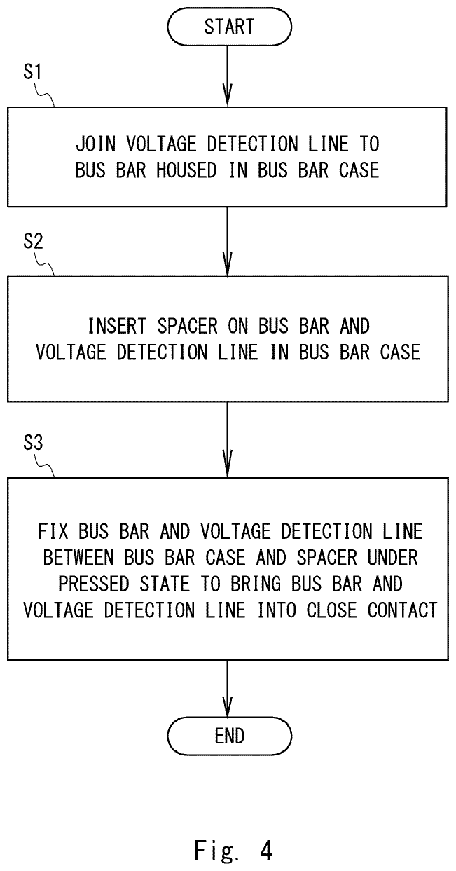

A voltage detection line is connected to the first bus bar module 103a and the second bus bar module 103b at positions indicated by asterisks in FIG. 3, and the battery ECU assembly 104 detects the voltage of each battery via the respective voltage detection lines. A connection method for performing connection between a bus bar and a voltage detection line will be described later with reference to FIGS. 4 to 6.

The battery pack 1 may include only one battery stack or may include three or more battery stacks, and it is preferable that a bus bar module corresponding to the adopted configuration is installed.

The battery ECU assembly 104 is connected to the first bus bar module 103a, the second bus bar module 103b, etc., and includes an ECU for controlling the supply of power from the battery to the load and charging of the battery. The ECU can perform control based on the voltage of each battery detected via the respective voltage detection lines.

The main unit 100 further includes a battery junction block assembly 105, a service plug grip 106, and a battery cooling blower assembly 107 attached to the housing 101.

As shown in FIG. 3, the BJB assembly 105 is a junction box equipped with relays such as SMR (System Main Relay) 105a, fuse, and the like. As shown in FIG. 3, the first battery stack 102a and the second battery stack 102b are connected to the power cable 105b via the BJB assembly 105. The SMR is a relay inserted into the high voltage circuit on the transmission path of high power from the first battery stack 102a and the second battery stack 102b to the driving inverter, etc., and switches the main power.

The service plug grip 106 can be removed during inspection and maintenance to shut off the high voltage at an intermediate position between the first battery stack 102a and the second battery stack 102b, thereby ensuring the safety of work. In the example shown in FIG. 3, a fuse 109 is disposed between the second battery stack 102b and the service plug grip 106.

The battery cooling blower assembly 107 is connected to the BJB assembly 105 configured to receive power. The battery cooling blower assembly 107 includes a blower for blowing air to cool the battery pack 1. Additionally, the main unit 100 includes a blown air discharge port 108.

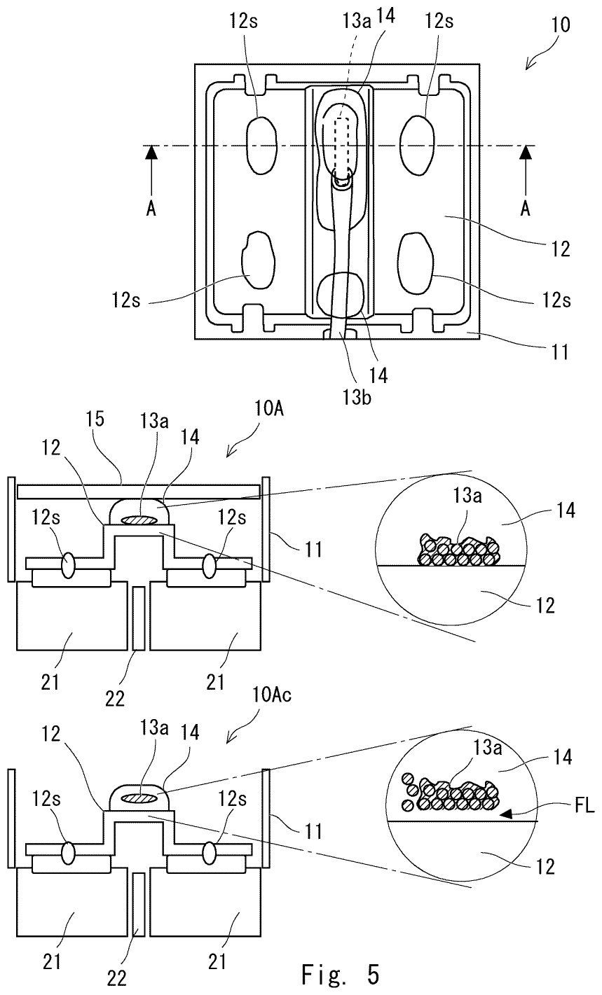

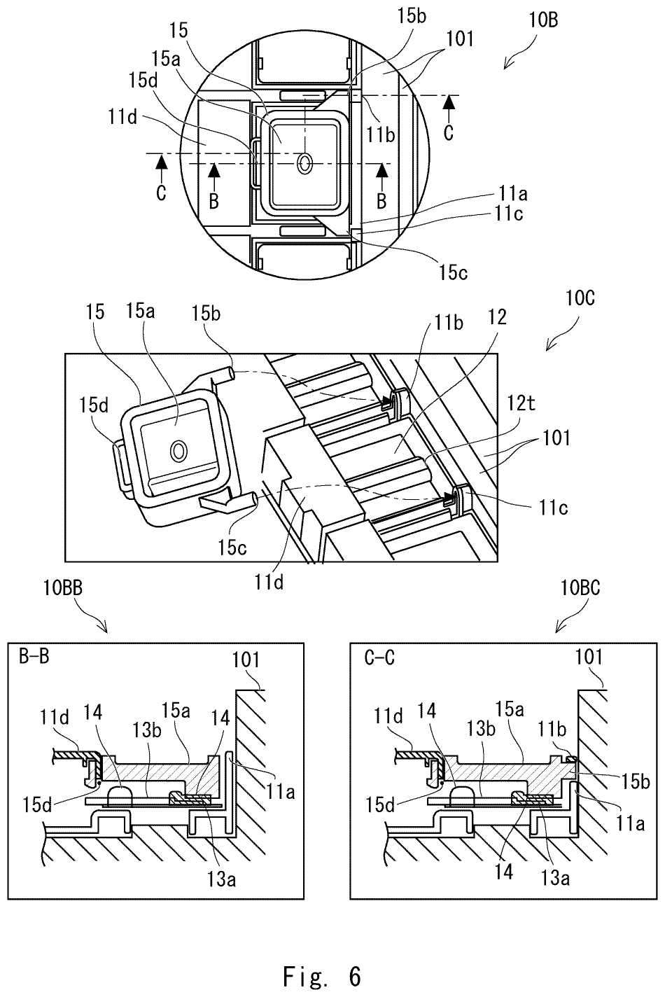

An example of the connection method according to this embodiment (hereinafter, referred to as this connection method) will be described with reference to FIGS. 4 to 6. FIG. 4 is a flow diagram for explaining an example of this connection method. FIG. 5 is a schematic diagram showing an example of connection adopting the connection method of FIG. 4 and an example of connection adopting a connection method of a comparative example. FIG. 6 is a schematic view showing a connection state according to the connection method of FIG. 4.

In this connection method, as shown in FIG. 4, a voltage detection line is first joined to a bus bar housed in a bus bar case (Step S1). This joining is performed by ultrasonic welding, for example, but may be performed by other joining methods.

A bus bar and a voltage detection line to be joined will be described with reference to FIG. 5. In FIG. 5, as shown in a top view of one of the joining parts 10 shown in FIG. 2, the bus bar 12 is disposed for electrically connecting the batteries 21 under a state in which the batteries are housed in a bus bar case 11 made of an insulating material. Each battery 21 represents two adjacent batteries of the batteries included in the first battery stack 102a and the second battery stack 102b. A separator 22 is disposed between the adjacent batteries 21. The bus bar case 11 has a structure in which it can be fixed in such a manner that the bus bar 12 does not slip out of the bus bar case 11 when housing the bus bar 12.

The bus bar 12 and the electrodes of each battery are joined by a laser bonding or the like in each joining site 12s. A voltage detection line 13 includes an electric wire 13a and an insulating coating 13b covering the electric wire 13a, and a tip of the electric wire 13a is exposed at a join point with the bus bar 12.

In Step S1, the tip of the electric wire 13a is joined to the bus bar 12. In FIG. 5, the bus bar 12 may have a shape such that the part where the voltage detection line 13 is joined is higher than the part where a battery 21 is joined, as illustrated in FIG. 5 as a joining part 10A, corresponding to the cross section of the joining part 10 taken along the A-A line in FIG. 5. In Step S1, an insulating member 14 for reinforcing the fixation with the bus bar 12 may be formed in this joining by coating or the like at the position of the tip of the electric wire 13a and the position of the insulating coating 13b.

Next, as illustrated as the joining part 10A in FIG. 5, a spacer 15 is inserted on the bus bar 12 and the voltage detection line 13 in the bus bar case 11 (Step S2), and the bus bar 12 and the spacer 15 are brought into close contact (Step S3). The spacer 15 can be made of an insulating material such as resin. In the joining part 10A, the spacer 15 is illustrated briefly, and an example of its detailed shape will be described later with reference to FIG. 6.

While the structure for carrying out such close contact will be described later with reference to FIG. 6, in Step S3, the bus bar 12 and the voltage detection line 13 are fixed between the bus bar case 11 and the spacer 15 under a pressed state, so that the bus bar 12 and the voltage detection line 13 are brought into close contact.

In the example of the joining part 10A, as shown in an enlarged view of a part thereof, the upper surface of the insulating member 14 coated on the tip of the electric wire 13a and the lower surface of the spacer 15 are brought into contact, and the bus bar 12 and the tip of the electric wire 13a of the voltage detection line 13 are brought into close contact by the spacer 15. In this contact, although not illustrated, the upper surface of the insulating member 14 coated on the insulating coating 13b and the lower surface of the spacer 15 are also brought into contact at the same time, and the bus bar 12 and the insulating coating 13b of the voltage detection line 13 may also be brought into close contact.

An example of the structure for performing the close contact described above will be described with reference to FIG. 6. In FIG. 6, as a top view of the joining part 10A shown in FIG. 5, a joining part 10B is shown, and a joining part 10C in which the spacer 15 is being inserted, which is a part of a process of forming the joining part 10B, is shown. In FIG. 6, a cross-sectional view of the joining part 10B taken along the line B-B is shown as a joining part 10BB, and a cross-sectional view of the joining part 10B taken along the line C-C is shown as a joining part 10BC.

As shown by the joining part 10B, the spacer 15 may be provided with spacer-side engagement parts 15b, 15c, and 15d for engagement with the bus bar case 11 in a main unit 15a thereof. It should be noted that the circular or elliptical part illustrated at the center of the main unit 15a in the joining part 10B is a mark or a protrusion which serves as a guide of the position to be pushed by an operator when the spacer 15 is housed in the bus bar case 11.

The bus bar case 11 may be provided with a plurality of case-side engagement parts 11b, 11c, and 11d on an inner circumference side of an upper-edge opening part in a main unit 11a thereof. The upper-edge opening part of the bus bar case 11 may be an opening part serving as a housing port of the bus bar 12, and an insertion port of the spacer 15. As exemplified by the joining part 10C, the case-side engagement parts 11b, 11c may be a recessed part formed in a direction perpendicular to the direction in which the battery 21 is joined to the bus bar 12, and in a direction perpendicular to the stacking direction of the battery 21. Also, as exemplified by the joining parts 10BB, 10BC, the case-side engagement part 11d can be a part where a protrusion projects toward a bottom face side of the bus bar case 11 is formed.

Also, the spacer 15 can be provided with the spacer-side engagement parts 15b, 15c, 15d which engage with the case-side engagement parts 11b, 11c, 11d and, respectively.

Then, as shown by the joining part 10C, the spacer-side engagement parts 15b, 15c are inserted into the case-side engagement parts 11b, 11c, respectively, and the main unit 15a is pushed in the direction of bottom face of the bus bar case 11 to thereby fix the spacer 15 to the bus bar case 11. With this fixation, the spacer 15 is fixed as shown by the joining parts 10BB, 10BC. In the joining part 10C, the reference numeral 12t denotes the part of the bus bar 12 where illustration of the voltage detection line 13 is joined in the bus bar 12 is omitted.

In this engagement, by utilizing the elastic force of the spacer 15, the spacer 15 is fixed to the bus bar case 11 to apply a load to the voltage detection line 13, and the bus bar 12 and the voltage detection line 13 can be fixed under a pressed state between the bus bar case 11 and the spacer 15. With such a fixation, the bus bar 12 and the voltage detection line 13 can be brought into close contact.

In this way, in the case where the spacer 15 is arranged so as to fill the opening space of the bus bar case 11, a pressing state can be created by the elastic force generated by the spacer 15, that is, a load can be applied. The material of the spacer 15 may be determined from the viewpoint of such elastic force and ease of attachment to the bus bar case 11.

The shapes of the spacer-side engagement part and the case-side engagement part are not limited to the illustrated examples. For example, like the case-side engagement part 11d, the case-side engagement parts 11b, 11c may be formed with a protrusion facing the bottom face side of the bus bar case 11. In this case, the case-side engagement parts 15b, 15c may be provided with a protrusion projecting from the bottom face side of the bus bar case 11 toward the upper-edge opening part while the main unit 15a of the spacer 15 is housed in the bus bar case 11.

In addition, not only the shapes of the spacer-side engagement part and the case-side engagement part are limited to those illustrated in the drawings but also the numbers thereof are not limited to three. By engaging a plurality of spacer-side engagement parts with a plurality of case-side engagement parts, the spacer 15 may be pressed against the bus bar case 11 and fixed. In other words, the shape and the number of the spacer-side engagement parts and the case-side engagement parts may be such that in the case where the main unit 15a of the spacer 15 is housed and fixed to the bus bar case 11, the bus bar 12 and the voltage detection line 13 are pressed and held by the main unit 15a and the bottom face of the bus bar case 11.

Next, in order to explain the effect of this embodiment, a comparative example is given. A connection method according to the comparative example described herein is a method in which a spacer is not disposed in the connection method according to this embodiment. The joining part connected by the connection method of the comparative example is the part shown as the joining part 10Ac in FIG. 5. In case the joining part 10Ac, as shown in an enlarged view of a part thereof, a gap FL is generated between the bus bar 12 and the tip of the electric wire 13a of the voltage detection line 13.

On the other hand, in the present embodiment, as shown in an enlarged view of a part of the joining part 10A in FIG. 5, no gap FL is generated between the bus bar 12 and tip of the electric wire 13a of the voltage detection line 13, and both are in brought in close contact with each other. Therefore, according to the present embodiment, connection between the bus bar 12 and the voltage detection line 13 can be made firmer than that in the comparative example.

Furthermore, in the comparative example, since an upper-edge opening part of the bus bar case 11 is left as it is, there is a possibility of electric shock in the case where reconnection between the bus bar 12 and the voltage detection line 13 is performed in an assembled battery pack. More specifically, after a battery pack is distributed on the market after completion of assembly thereof or during inspection of the assembled battery, a defect in the joining between the bus bar 12 and the voltage detection line 13 may be found due to poor crimping of the voltage detection line 13 of the battery cells, which are respective batteries. However, even in the case where such a defect in the joining is found, it cannot be replaced because the bus bar 12 is welded to the battery cells. Therefore, in the comparative example, when performing repairment of the joining between the bus bar 12 and the voltage detection line 13, that is, performing re-joining, the cover part 200 is first removed, but since the part to be repaired is the active part, there is a possibility of electric shock in the process of removing the cover part 200 or after it is removed.

On the other hand, in the battery pack 1 according to this embodiment, the spacer 15 for performing this close contact is arranged at the upper-edge opening part of the bus bar case 11. Therefore, in the case of performing re-connection between the bus bar 12 and the voltage detection line 13 in the assembled battery pack 1, since the active part is covered by the spacer 15 in the case where the cover part 200 is removed, the possibility of electric shock can be reduced. That is, according to this embodiment, even in the case where a crimping failure of the voltage detection line of the battery cell is found after the battery pack 1 is assembled, repairment can be performed safely in terms of the possibility of electric shock.

As described above, in the connection method according to this embodiment, the bus bar 12 and the voltage detection line 13 are fixed in close contact with each other using the spacer 15 made of an insulating material. Therefore, according to the connection method according to this embodiment, the possibility of electric shock can be reduced in the case of performing re-connection between the bus bar 12 and the voltage detection line 13 in an assembled battery pack.

Further, as exemplified by the joining part 10B, the possibility of electric shock during repairment can be further reduced by arranging the spacer 15 so as to close the upper-edge opening part of the bus bar case 11. However, the possibility of electric shock can be reduced even in the case where the spacer 15 closes only a part of the upper-edge opening part.

In addition, since the spacer 15 is fixed using the recessed part of the bus bar case 11, the battery pack 1 can be said to be space-efficient. In addition, since the battery pack 1 has a structure in which the spacer 15 is arranged on an upper-edge opening part of the bus bar case 11, it can be said that the anti-electric-shock measures (i.e., insulation measures) can be taken in the battery pack 1 with good space efficiency.

In addition, in this embodiment, the joining part between the bus bar 12 and the voltage detection line 13 can be located on the bus bar 12 in the bus bar case 11. Therefore, according to this embodiment, it is not necessary to dispose the joining part between the bus bar 12 and the voltage detection line 13 outside the bus bar case 11 such as a place separated from the bus bar 12, and a space for the joining part is not required.

The battery pack 1 connected by the connection method as described above has the following configuration. That is, the battery pack 1 includes the bus bar 12, the bus bar case 11 made of an insulating material for housing the bus bar 12, the voltage detection line 13 joined to the bus bar 12 in the bus bar case 11, and the spacer 15 made of an insulating material.

Here, the spacer 15 is fixed to the bus bar case 11. Furthermore, the bus bar 12 and the voltage detection line 13 are fixed in close contact with each other between the bus bar case 11 and the spacer 15.

With this configuration, the possibility of electric shock in the battery pack 1 can be reduced in the case where reconnection is performed in the assembled battery pack 1.

In addition, as described above, the battery pack 1 includes a plurality of case-side engagement parts in the bus bar case 11 and the spacer 15 has a plurality of spacer-side engagement parts that engage with the case-side engagement parts. By adopting this configuration, the spacer 15 can be easily fixed and removed to and from the battery pack 1 in manufacturing or repairing the battery pack 1.

### Other Embodiments

It should be noted that the present disclosure is not limited to the above-described embodiments, and may be appropriately modified without departing from the gist thereof. For example, the battery pack, the bus bar, and the voltage detection line described in the above-described embodiments may function as a battery pack, a bus bar, and a voltage detection line, respectively, regardless of the configuration, the shape, the arrangement, etc. thereof. The battery pack described in the above-described embodiments is not limited to a battery pack equipped with a hybrid battery mounted on a hybrid vehicle, but may also be a battery pack mounted as a battery of an electric vehicle, or a battery pack mounted on another type of vehicle such as a motorcycle, train, or ship.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connection method for performing connection between a bus bar and a voltage detection line in a battery pack, comprising:
joining the voltage detection line to the bus bar housed in a bus bar case made of an insulating material; and
fixing a spacer to the bus bar case under a state in which the bus bar and the voltage detection line are pressed between the bus bar case and the spacer made of an insulating material to thereby bring the bus bar and the detection line in close contact with each other.

2. The connection method according to claim 1, wherein
the bus bar case is provided with a case-side engagement part on an inner circumference side of an upper-edge opening part,
a plurality of the spacer-side engagement parts disposed in the spacer are engaged with the case-side engagement part to thereby fix the spacer to the bus bar case.

3. The connection method according to claim 2, wherein the spacer is arranged so as to block the upper-edge opening part of the bus bar case.

4. The connection method according to claim 1, wherein the spacer is arranged so as to block an upper-edge opening part of the bus bar case.

5. A battery pack, comprising
a bus bar;
a bus bar case made of an insulating material for housing the bus bar;
a voltage detection line joined to the bus bar in the bus bar case; and
a spacer made of an insulating material and fixed to the bus bar case,
wherein
the bus bar and the voltage detection line are fixed in close contact with each other between the bus bar case and the spacer.

6. The battery pack according to claim 5, wherein
the bus bar case comprises a case-side engagement part on an inner circumference side of an upper-edge opening part,
the spacer comprises a plurality of spacer-side engagement parts that engage with the case-side engagement part.
